(19) United States
(12) Patent Application Publication
(10) Pub. No.: US 2012/0075166 A1
(43) Pub. Date: Mar. 29, 2012

(54) ACTUATED ADAPTIVE DISPLAY SYSTEMS

(75) Inventors: Stefan Marti, Santa Clara, CA (US); Seung Wook Kim, Cupertino, CA (US)

(73) Assignee: SAMSUNG ELECTRONICS CO. LTD., Suwon City (KR)

(21) Appl. No.: 12/893,868

(22) Filed: Sep. 29, 2010

(51) Int. Cl. G09G 5/00

(52) U.S. Cl. 345/1.1

(57) ABSTRACT

Adjustable, adaptive display system having individual display elements is able to change its configuration based on a user's movements, position, and activities. A method of adjusting a display system tracking a user is tracked using a camera or other tracking sensor, thereby creating user-tracking data. The user-tracking data is input to an actuator signal module which generates input signals for one or more actuators. The input signals are created, in part, from the user-tracking data. Two or more display elements are actuated using the one or more actuators based on the input signals. The display elements may be planar or curved. In this manner, a configuration of the display system adapts to user movements and adjusts systematically. This provides for a greater amount of a user's human visual field (or user FOV) to be filled by the display system.

### BACKGROUND OF THE INVENTION

1. Field of the Invention

The present invention relates generally to display and computing systems. More specifically, the invention relates to interactive and adaptive displays, multi-display platforms, and actuated displays that react to a viewer's actions, position, and orientation.

2. Description of the Related Art

In many living and working environments in modern society, display devices have become central elements. It is not uncommon that a display of some type is the focus of our attention, whether that display is a laptop or desktop computer monitor, a TV, a mini laptop monitor, an e-book reader, a mobile computing device, and so on. We are now seeing displays in more places, ranging from kitchens to cars. In some environments they are built-in or stationary (home entertainment systems, desktop computers) and in other cases they may be mobile or nomadic. The displays themselves are also becoming more sophisticated (e.g., lighter, thinner, more flexible, curved).

However, despite the increasing prevalence of displays in everyday life, they have fallen short of being able to adapt to a user's activities and positions. Users are still manually adjusting displays, such as the display's angles and height, to suit the user's position, orientation, or activity. For example, today's computer displays do not adjust their physical orientation to the user's relative position or eye gaze, unless the user manually rotates or shifts the display. A user moving in a kitchen watching TV or referring to content on a computer display (e.g., a cooking video) has to either frequently move the display so that it faces her direction or turn her head and body in odd or unusual angles to view the display, which is typically stationary and is set in a single configuration. As such, many displays are not ergonomic; users often have to make manual adjustments to avoid muscle strain, poor posture, and the like.

In addition, displays currently provide either (mostly) vertical or (occasionally) horizontal display space only, and are not able to transition between these two configurations easily. In case of multiple display setups, screens are often tiled in arrays with little or no flexibility, so their formation cannot be adjusted in a systematic way.

It would be desirable to have a display system that is able to change its own configuration or shape (of its entire structure) dynamically and adaptively. It would also be desirable if it could actively track a user's position and adjust to maximize the user's field of view and change the curvature of a display space.

### SUMMARY OF THE INVENTION

In one aspect of the present invention, a method of adjusting a display system is described. A user is tracked by the system, for example, by a camera or other tracking sensor, thereby creating user-tracking data. The user-tracking data is input to an actuator signal module which generates input signals for one or more actuators. The input signals are created, in part, from the user-tracking data. Two or more display elements are actuated using the one or more actuators based on the input signals. In one embodiment, the display elements are planar. In this manner, a configuration of the display system adapts to user movements and adjusts systematically.

In one embodiment, the input signals are generated in part by analyzing a current configuration of the actuators in the display system. Actuator position data is also inputted to the actuator signal module. In another embodiment, when 3D content is displayed on the system, display system configuration data is inputted to one or more 3D renderers for implementing virtual cameras. In one embodiment, tracking a user includes tracking the user's movements, eye gaze direction, and user position. In another embodiment the display system transitions between a horizontal configuration and a vertical configuration, where configuration includes orientation, shape, and curvature of display elements.

In another aspect of the invention, a method of adjusting a display system having one or more curved display elements is described. As in the previous embodiment, a user is tracked by the system, thereby creating user-tracking data. The user-tracking data is input to an actuator signal module which generates input signals for one or more actuators. The input signals are created, in part, from the user-tracking data. One or more curved display elements are actuated using the one or more actuators based on the input signals. In this manner, a configuration of the display system adapts to user movements and adjusts systematically. Similarly, this embodiment provides an extended FOV to the user. In another embodiment, the display system includes at least one curved display element or at least two planar display elements.

Another aspect of the invention is an actuated display system that is able to dynamically adjust its display elements to a user's movements, activities, position, and gaze. The display system includes at least two planar display elements, at least one curved display, or a combination of both types of displays. A user tracking sensor detects movements and positions of the user. In one embodiment, the sensor is able to detect a user approaching or walking towards the display system and track the user's movements and gaze when in front of or in the display space of the display system. An actuator signal module accepts user tracking data from the sensor and uses display system configuration data to generate signals to adjust one or more actuators. In one embodiment, the actuators may be servos, hydraulic, or electric or any other suitable mechanical actuator.

### BRIEF DESCRIPTION OF THE DRAWINGS

References are made to the accompanying drawings, which form a part of the description and in which are shown, by way of illustration, particular embodiments:

FIG. 1 is a diagram showing two side-view illustrations of an actuated display system in accordance with one embodiment;

FIG. 2 is a diagram showing a display system having four display elements in accordance with one embodiment;

FIG. 3 is an illustration showing top views of a user looking at display elements having an actuated curvature;

FIG. 4 is an illustration showing side-view illustrations of a user and a display system in accordance with one embodiment;

FIG. 5 is an illustration showing top-view of a user standing in front of a display system having planar display elements in accordance with one embodiment;

FIG. 6 is a side-view illustration of a user approaching a display system having planar displays in accordance with one embodiment;

FIG. 7 is an illustration showing top-views of a user facing various display systems;

FIG. 8 is an illustration showing top-views of a user facing various display system having three display elements;

FIG. 9 is a block diagram showing components in an actuated, adjustable display system in accordance with one embodiment;

FIG. 10 is a flow diagram of a process of adjusting an actuated display system in accordance with one embodiment; and

FIGS. 11A and 11B show one physical implementation of a computing system suitable for implementing the present invention.

### DETAILED DESCRIPTION OF THE INVENTION

Various embodiments of the present invention describe display systems that adjust overall orientation, shape, and, where possible, curvature in accordance with a user's position and activity. In one embodiment, a display system, as used herein, is made up of multiple (two or more) planar display components. In another embodiment, a display system may include a single curved display component. A display component is referred to as a display element or simply as a display. Other lay or common terms used to refer to display component are “monitor” and “screen,” however, to avoid confusion, the description herein uses the terms display or display element to refer to a single display component. As noted, a display system consists of either two or more separate planar display elements which are actuated separately or a single curved display element. A curved display element may be a concave, convex or irregularly curved display which dynamically changes parameter of its curvature via a single or multiple actuators. A display system may also be a combination of planar or curved display elements. Various examples of display system configurations are shown below.

As noted, display elements are actuated to change a display system configuration. In one embodiment, display actuation generally means that a display system can change the position of some or all of its display elements, or the curvature of a curved display element, depending on factors such as a user's location, position, and activity type. Examples of activity type include standing, sitting or approaching or walking in relation to a display system. For example, a user walks or approaches a space in close proximity or in the immediate space around a display system. This space may be referred to as a “display space.” These concepts and terms are explained in more detail in the figures below.

In the display system of the present invention, implementing display actuation optimizes the view for the user. For example, the user may always look at all display elements perpendicularly, regardless of how far or close the user is from the display elements, i.e., regardless of the user's position in the display space. In one embodiment, display systems having curved display elements are able to optimize or expand the amount of the user's FOV or human visual field that the display system is able to fill in a given space for the display system installation. Actuation ensures this optimization regardless of distance and angle of the user in the display space. It is useful here to describe what is meant by FOV. A user has a human visual field. This is generally about 200 degrees in the horizontal (left-right) direction and 135 degrees in the vertical (up-down) direction. This human visual field (i.e., the user's FOV) does not change. The goal is to have a display system that is able to occupy or fill as much of the human visual field as possible. If a display space is able to provide 200 degrees of horizontal viewing and 135 degrees of vertical viewing, it may be described as an optimal display system; a system that occupies the maximum human visual field. Display systems described in the various embodiments of the present invention occupy a certain percentage or fraction of this optimal or maximum human visual field. The various embodiments of the display systems described increase the amount of the human visual field that is filled or occupied by the actuated display elements of the present invention. Thus, the invention is not about increasing the user's FOV, but about increasing the percentage of the user's FOV or human visual field that the display space is able to fill. In one embodiment, this percentage or fraction may be an angular measurement. For example, if a user holds a cell phone at a given distance (e.g., arm's length), it covers some fraction of the user's whole human visual field. This fraction or number may be a combination of a horizontal and vertical angle, or a percentage of the human visual field. The display systems of the present invention are also able to include more privacy for a user given that actuated display systems can encompass or encapsulate a user, thereby restricting unwanted viewing from outside onlookers.

As noted, actuated display systems can adjust to different types of user activity. Actuation of display elements enables the user to stand or sit in front of the display system using both horizontal and vertical display surfaces (enabling surface computing), or move around in a display space (e.g., in a kitchen or room). In one embodiment, display actuation, in a wider sense, is able to expand the spatial boundaries of a user's activity.

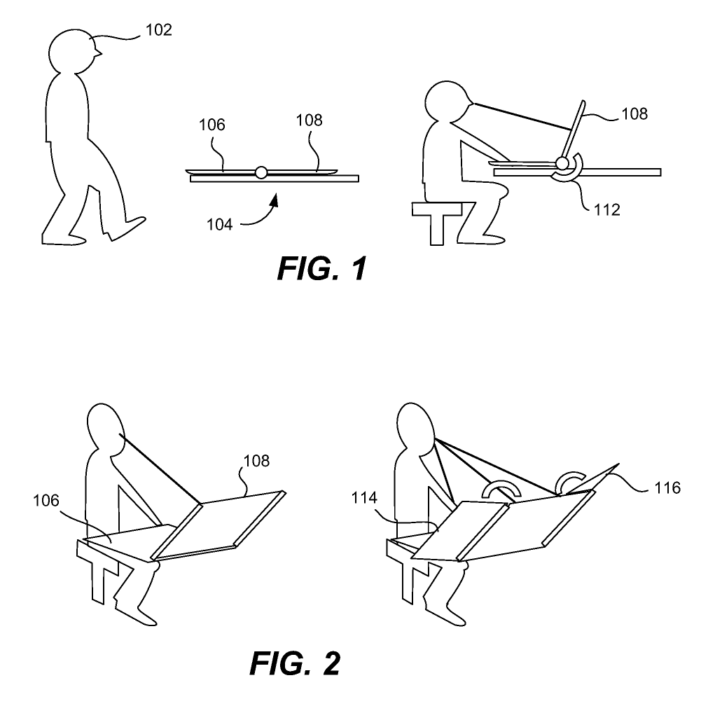

FIG. 1 shows two side-view illustrations of an actuated display system in accordance with one embodiment. In this example, a user 102 walks up to a laptop or tablet computer 104 configured initially in a flat horizontal position. This may be referred to as a default (“idle”) configuration. There are two display elements, display 106 and display 108, which make up a display system. As user 102 walks towards and sits down in front of computer 104 or as soon as the user enters the system's display space, display element 108 actuates to an upward vertical position as shown and indicated by curved line 112. For example, this may be done using a horizontal hinge. Display element 106, for example, may display a touch screen keypad. The angle of actuation depends on the user's movements and position. The device can contain additional display elements, e.g., attached to the upper display element with vertical hinges. These third and fourth display elements can be folded away for transportation, and fold out (“unfold”) with actuators to orient themselves towards the user.

FIG. 2 shows a display system having four display elements. Two of them are the same as the display elements in FIG. 1. Two more actuated displays 114 and 116 with, for example, vertical hinges open to improve the amount of the user's FOV that is occupied by the display system and overall view of the content. As described, display elements may unfold or actuate based on the user's movements, including the user's eye gaze and face orientation. As noted above, the display space may be described as the space in front of or around the display system, such as where the user is sitting. The user enters the display space in FIG. 1 as he walks closer to the display system. He is in the display space when he is within the field of detection of the user tracking sensors (not shown) as described below. In FIG. 2 actuators are implemented using three hinges, one horizontal and two vertical. In an extreme case, each display may have up to six actuators to enable six degrees of freedom.

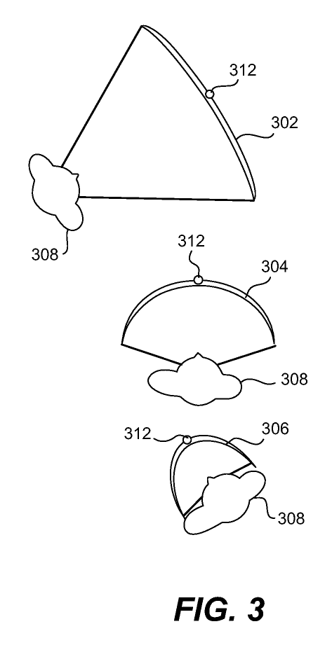

FIG. 3 is an illustration showing top views of a user looking at display elements having an actuated curvature. With curved displays, the actuator may be operating within the display (e.g., multiple mini-motors) or attached to the outside of the display. Actuators for curved display (and planar ones) are commercially available. Actuator technology for various types of display elements is known in the art. A display element may have different curvatures, shown as 302, 304, and 306 in FIG. 3. The degree of curvature may depend on the position and orientation of a user 308. In the examples shown in FIG. 3, the degree of curvature of the display element increases the closer the user stands or sits in front of the display system. In each case, the user may be said to be in the display space of the display system and the user-tracking sensors are able to detect the user's movements. The sensor may be at any suitable location in the display system, such as at hinge location 312 in the examples. Although user 308 is not shown as moving in FIG. 3, the examples show that as user 308 moves closer to the display system, the display's curvature changes or actuates so that it is more curved and as user 308 moves away, the curvature becomes more planar. In each case, the curvature adjusts to improve the user's overall view and, specifically, the amount of the user's FOV or human visual field that is occupied by the display system.

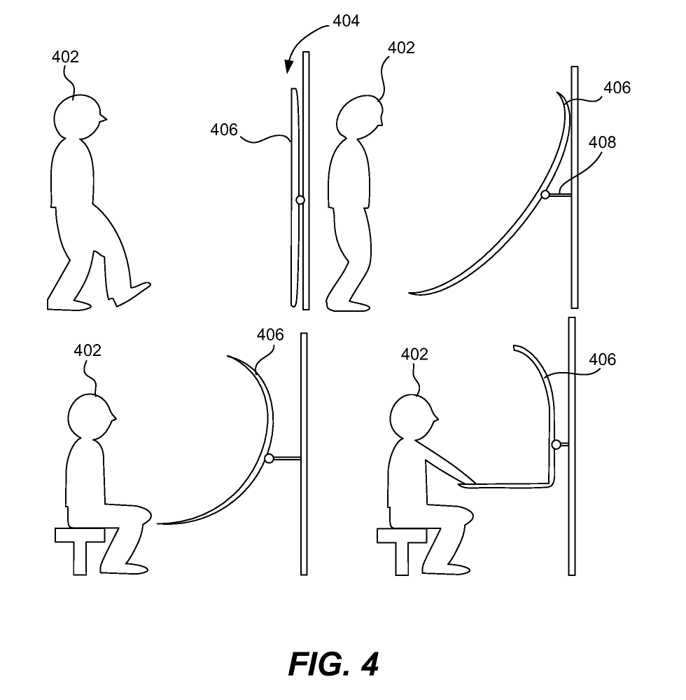

FIG. 4 shows side-view illustrations showing a user and a display system in accordance with one embodiment. Shown are actuated display systems having irregular curved display elements that are initially oriented horizontally and generally remain in a horizontal orientation. A user 402 approaches a display system 404 having a single curved display element 406 which is in a default configuration in this case nearly or entirely vertically planar. As the user approaches display system 404 or enters the display space, the curvature of display element 406 adjusts to the user position and gaze. This is done using an actuator arm and mount 408. As shown, user 402 is looking down at a slight angle which causes display element 406 to adapt to the user's gaze. As user 402 changes position and activity, from standing to sitting, the curvature of display element 406 further adapts by increasing the angle of curvature to adjust to the user's body position, which is now lower from sitting. The configuration of the display system 404 changes again when user 402 moves his arms to type or touch part of display element 406. When this movement (i.e., lifting of hands and arms) is detected by a sensor (not shown), the configuration of display system 404 changes to adapt to the user's activity. In this example, the curvature is highly irregular and non-symmetrical, although still feasible using current curved display actuation technology.

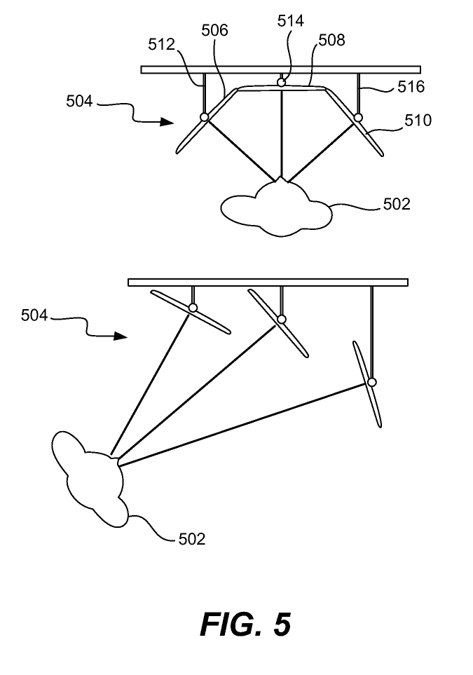

FIG. 5 shows top-view illustrations of a user 502 standing in front of a display system 504 having planar display elements 506, 508, and 510. The display elements are configured as a (short) array of tiles. In one embodiment, each vertically actuated display elements has an actuator arm and mount (or display arm) 512, 514, and 516. Display system 504 has both rotational and translational display mount actuation. The three vertically actuated display elements 506, 508, and 510 have pan and “Z” actuation. As user 502 moves to the left, the displays adjust their mounts and angles so that amount of the FOV of user 502 filled by the display system is optimized. The display elements change their angles so that the display system configuration adjusts to the user's new position.

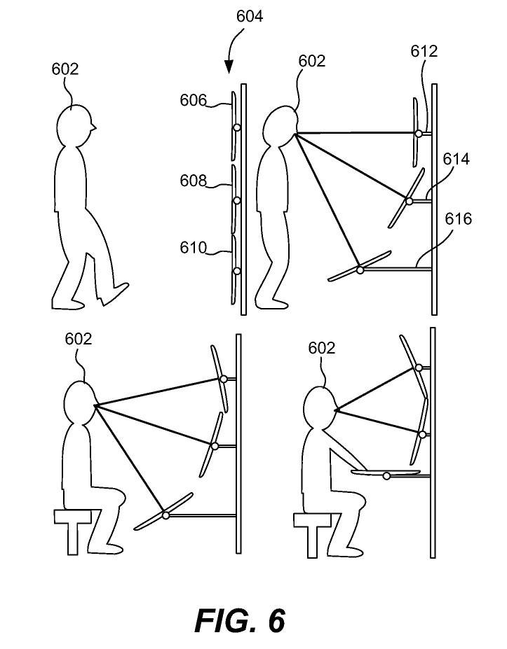

FIG. 6 is a side-view illustration of a user approaching a display system having planar displays in accordance with one embodiment. As a user 602 approaches a display system 604, consisting of three initially horizontally-oriented actuated displays 606, 608, and 610, display system 604 is in a default configuration. It shows the displays aligned in a vertical array. As user 602 enters a display space, each display element actuates and system 604, as a whole, adapts to a configuration where the view for user 602 is optimized. This is done using actuation mounts and arms 612, 614, and 616, which can extend out from a wall. This is also shown in FIGS. 4 and 5. As user 602 changes position, from standing to sitting to sitting with hands on display element 610, the configuration of system 604 adapts to the user's position. As shown in FIG. 6, display 610 adjusts from being completely vertical to being horizontal. This example shows that display elements can transition between generally horizontal and generally vertical depending on the user's movements and position. The user-tracking sensor may be placed above actuated display 606.

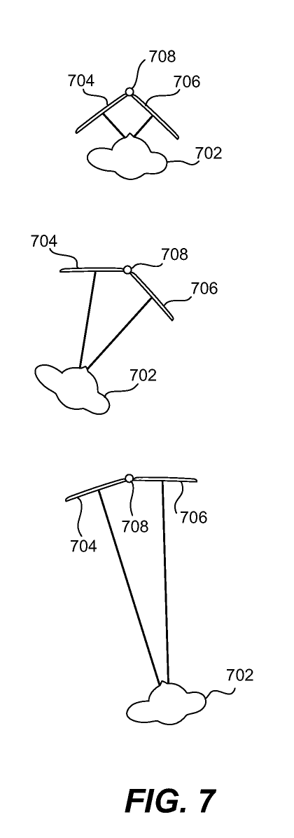

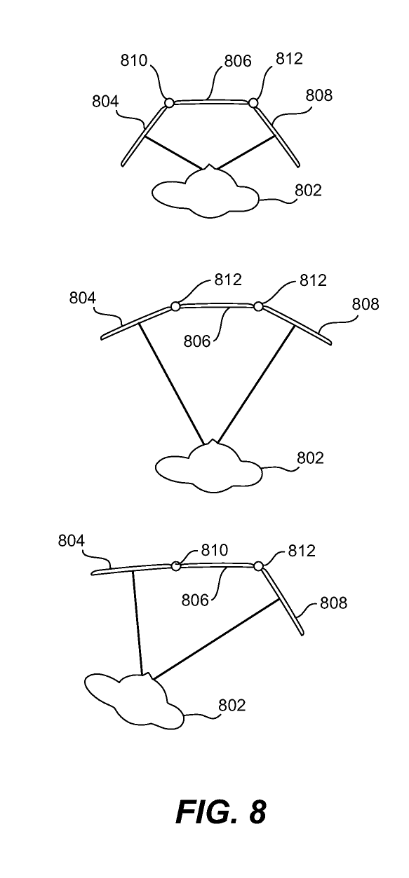

FIG. 7 shows top-view illustrations of a user facing a display system in various actuation states. A user 702 is facing display system having two symmetrically arranged, vertical display elements 704 and 706. The configurations show displays 704 and 702 at angles that are best suited for user 702 standing at specific distances and positions (angles) as shown. As in the other figures, the angle of actuation is greater when user 702 further away from the system and smaller when he is closer. Again, this optimizes the amount of the user's FOV that is filled by the display system. A top-view of hinge 708 is shown between the display elements. FIG. 8 shows top-view illustrations of a user 802 facing a display system having three display elements 804, 806, and 808. The configurations show the angles best suited for the user standing at a specific distance. One configuration shows an asymmetrical arrangement where the user is not standing directly in front of the display system. The angles of the displays are configured to maximize the amount of the user's FOV or human visual field that is filled by the display system. Here, a top-view of two hinges 810 and 812 are shown between the display elements. The user may stand or sit in a space that is close to the display system, typically resulting in a smaller angle between the displays, or can stand further away, resulting in larger angles between the displays.

In another embodiment, a foldable or rolled up flexible display system may be implemented in a handheld or mobile platform or device, such a system may be mechanically actuated based on the user's tasks or movements. In yet another embodiment, cameras that have “articulating screens” (pivoting view-finding screens) are generally passive in that they have to be adjusted manually. In one embodiment of the present invention, such displays can be actuated or pivot depending on the user's position. This is useful, for example, when taking self portraits (images which contain at least partially the person taking the picture).

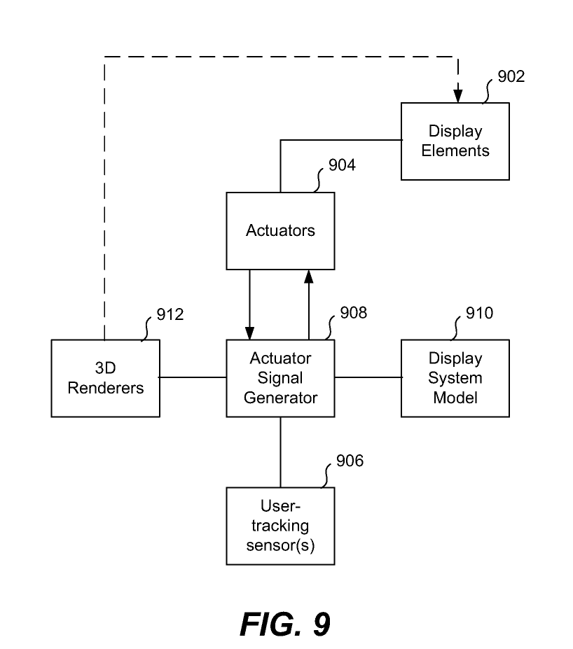

FIG. 9 is a block diagram showing components in an actuated, adjustable display system in accordance with one embodiment. As shown in the numerous examples above, a display system includes at least two or more planar display elements or at least one curved display. These display elements are represented generally by item 902. The displays may be LCD or plasma or may have flexible or rigid substrates. Displays are connected to or contain actuators 904. As is known in the art, there are various types of actuation. Actuation, in its simplest form, can be similar to actuating motorized wall mounts for flat displays (e.g., TVs). Such mounts often allow the display element to pan or tilt (two rotational degrees of freedom). Actuators may also be components of the display itself. For example, a curved display may have many small motors that enable it to change curvature. Actuators can be implemented using electric (servos, stepper motors, and so on), hydraulics (e.g., pneumatic), shape memory alloy, piezoelectric technology, MEMS technology, and others.

In more advanced actuation implementations, the actuation may include telescopic actuation (linear degrees of freedom), which can enable up to 6DOF (rotational and translational). In such advanced implementations, each display element can be positioned freely in space.

In addition, actuation may also refer to rotational actuation. For example, if a user tilts his head sideways (rolls), then the display may tilt sideways (roll) synchronously with the user. This means the device physically adjusts to the tilt angle (roll angle) of the user's head. (Note that this is similar, but not the same, as a device adjusting virtually, by rotating the display content to the tilt angle of the user's head.

As shown, in some of the examples, actuation may specifically include irregular deformations of the display system. For example, an array of small localized actuators can be used to deform a display system configuration in various, irregular ways.

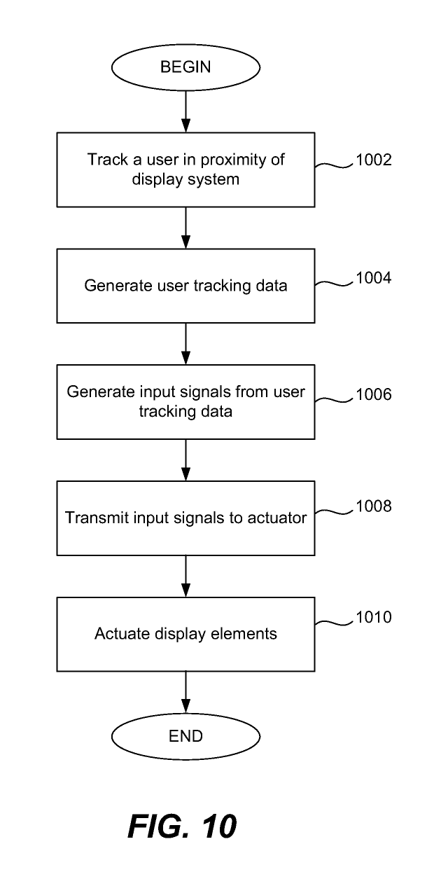

User tracking sensors 906 tracks the user's movements in the display space. In the described embodiment, sensor 906 is a camera. It can be a motion sensor, thermal-based sensor, audio-based sensor, or any other sensor (or combinations thereof) able to accurately track the user motions. Sensor 906 is able to detect movements by the user and, in some embodiments, it can also track changes in the user's gaze and face angle (i.e., the direction in which the user is looking). In other embodiments, sensor 906 is also able to detect multiple users in the display space, as described below in FIG. 10. Sensor 906 transmits signals to an actuator signal generator module 908. This software module accepts signals from sensor 906 as input. It also uses a display system model 910. Model 910 is generally static and essentially reflects the configuration of the display elements, such as hinge placement, physical display size, and other physical characteristics of the display system that normally do not change. In one embodiment, model data 910 may be stored in signal generator module 908.

In another embodiment, signal generator 908 transmits display system configuration or position data to three-dimensional renderer 912 for enabling virtual cameras if the content being displayed is spatial or 3D content. The display system can be implemented for two types of content. One may be referred to as generic content, which is displayed or processed using user tracking data only and actuators that dynamically adjust the position and orientation of some or all display elements. The other type of content is spatial content, which is processed using user tracking data, actuators that dynamically adjust the position and orientation of some or all display elements, as well as with dynamic 3D renderers 912. These renderers adjust the position and orientation of one or more virtual cameras of display elements 902.

FIG. 10 is a flow diagram of a process of adjusting an actuated display system in accordance with one embodiment. At step 1002 the display system tracks a user in the display space of the system. More specifically, depending on the type of user tracking sensor used, a user is detected within the range of a sensor and the sensor begins tracking the user's movements. In the described embodiment, the sensor is a camera and the user is tracked once he enters the camera's FOV. The user may then be described as being within the display space of the system. In other embodiments, there may be more than one sensor. For example, there may be a motion sensor to detect that a user is approaching the display system (e.g., is less than four feet away), at which time some or all of the displays open or unfold from an idle or folded position. A second sensor, such as a camera, may then detect more subtle movements by the user once he is in the display space, such as the user's gaze, facial or head movements, arm or hand movements, and the like. At step 1004 user-tracking data is generated by the one or more sensors. The properties and features of this data will depend on the type of user-tracking sensor used.

At step 1006 the display system generates input signals for an actuation module using the user tracking data. This may be done using a software module that accepts the user tracking data as input and transforms the data so that it can be processed by an actuation module. At step 1008 the input signals are transmitted to an actuation module which may include actuators and a control module. Various types of actuators are described above and several are commercially available that would be suitable for the display system. In one embodiment, the control module may consist of hardware and software, which accepts as input one or more signals. For example, a serial port signal which indicates the desired position of an actuator, such as the value “12” for an actuator with a range of “1-100” which means the actuator will go to a particular position to one extreme of its range. Upon accepting the input signal, the module generates a signal that the actuator can process (e.g., a continuous pulse with modulated signal, commonly used in servo motors). At step 1010 the one or more displays are actuated. If the displays are planar, an actuator moves at least two displays relative to each other to adapt to the user's activities and position.

If there is more than one user, some display elements can actuate for one user and other displays can actuate for a second user. A single tracking sensor 906 is able to track multiple users within its FOV. Thus, in a display system having many display elements (e.g., 20 or 30 displays), some can adjust to improve the view and expand the amount of the user's FOV that is filled by the display system for one user and others can adjust to maximize the view for other users.

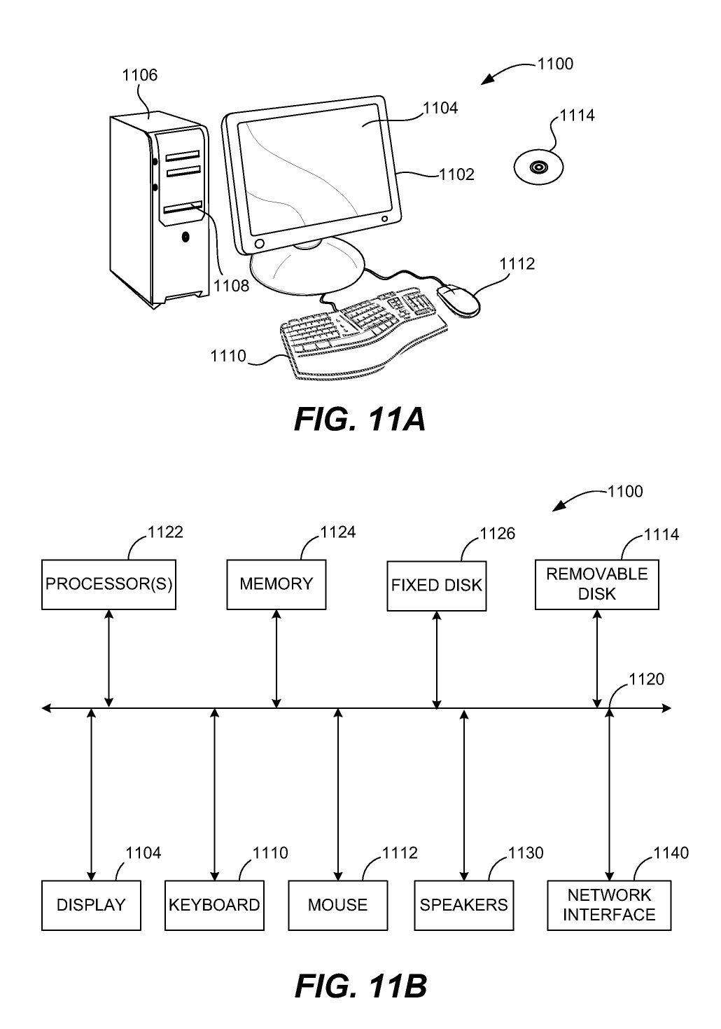

The display system described above operates with a computing device. For ease of illustration, the computer was not shown in the figures so that the display system could be shown more clearly. FIGS. 11A and 11B illustrate a generic computing device suitable for implementing specific embodiments of the present invention. FIG. 11A shows one possible physical implementation of a computing system. In one embodiment, system 1100 includes a display 1104. It may also have a keyboard 1110 that is shown on display 1104 or may be a physical component that is part of the device housing. It may have various ports such as HDMI or USB ports (not shown). Computer-readable media that may be coupled to device 1100 may include USB memory devices and various types of memory chips, sticks, and cards.

FIG. 11B is an example of a block diagram for computing system 1100. Attached to system bus 1120 is a variety of subsystems. Processor(s) 1122 are coupled to storage devices including memory 1124. Memory 1124 may include random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 1126 is also coupled bi-directionally to processor 1122; it provides additional data storage capacity and may also include any of the computer-readable media described below. Fixed disk 1126 may be used to store programs, data and the like and is typically a secondary storage medium that is slower than primary storage. It will be appreciated that the information retained within fixed disk 1126, may, in appropriate cases, be incorporated in standard fashion as virtual memory in memory 1124.

Processor 1122 is also coupled to a variety of input/output devices such as display 1104 and network interface 1140. In general, an input/output device may be any of: video displays, keyboards, microphones, touch-sensitive displays, tablets, styluses, voice or handwriting recognizers, biometrics readers, or other devices. Processor 1122 optionally may be coupled to another computer or telecommunications network using network interface 1140. With such a network interface, it is contemplated that the CPU might receive information from the network, or might output information to the network in the course of performing the above-described method steps. Furthermore, method embodiments of the present invention may execute solely upon processor 1122 or may execute over a network such as the Internet in conjunction with a remote processor that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are illustrative and not restrictive, and the invention is not to be limited to the details given herein, but may be modified within the scope and equivalents of the appended claims.

What is claimed is:

1. A method of adjusting a display system, the method comprising:
tracking a user thereby creating user tracking data;
inputting the user tracking data to an actuator signal module;
generating input signals for an actuator, the input signals created in part from the user tracking data; and
actuating two or more display elements using actuators based on the input signals, wherein a configuration of the display system adapts to user movements and adjusts systematically.

2. A method as recited in claim 1 wherein generating input signals further comprises:
examining a current configuration of the display system.

3. A method as recited in claim 1 wherein an amount of a user human visual field that is filled by the display system is increased.

4. A method as recited in claim 1 wherein a display element in the display system has its own renderer.

5. A method as recited in claim 1 wherein tracking a user further comprises tracking user movement and user position.

6. A method as recited in claim 5 further comprising:
tracking a user face and a user gaze.

7. A method as recited in claim 5 further comprising: tracking a user hand.

8. A method as recited in claim 1 further comprising:
inputting user tracking data to a renderer.

9. A method as recited in claim 1 further comprising:
adjusting the display system configuration according to a user gaze, thereby adapting to user movements.

10. A method as recited in claim 1 further comprising:
transitioning the display system configuration between a horizontal configuration and a vertical configuration, wherein configuration includes orientation, shape, and curvature of display elements.

11. A method as recited in claim 1 wherein the two or more display elements are planar.

12. A method of adjusting a display system, the method comprising:
tracking a user thereby creating user tracking data;
inputting the user tracking data to an actuator signal module;
generating input signals for an actuator, the input signals created in part from the user tracking data; and
actuating a curved display element using an actuator based on the input signals, wherein a configuration of the display system adapts to user movements and adjusts systematically.

13. A method as recited in claim 12 wherein generating input signals further comprises:
examining a current configuration of the display system.

14. A method as recited in claim 12 wherein an amount of a user human visual field that is filled by the display system is increased.

15. A method as recited in claim 12 wherein a display element in the display system has its own renderer.

16. A method as recited in claim 12 wherein tracking a user further comprises tracking user movement and user position.

17. A method as recited in claim 16 further comprising:
tracking a user face and a user gaze.

18. A method as recited in claim 16 further comprising:
tracking a user hand.

19. A method as recited in claim 12 further comprising:
inputting user tracking data to a renderer.

20. A method as recited in claim 12 further comprising:
adjusting the display system configuration according to a user gaze, thereby adapting to user movements.

21. A method as recited in claim 12 further comprising:
transitioning the display system configuration between a generally horizontal configuration and a generally vertical configuration, wherein configuration includes orientation, shape, and curvature of display elements.

22. An apparatus for adjusting a display system, the apparatus comprising:
means for tracking a user, creating user tracking data;
an actuator signal module for accepting the user tracking data as input;
means for generating input signals for an actuator, the input signals created in part from the user tracking data; and
means for actuating two or more display elements based on the input signals, wherein a configuration of the display system adapts to user movements and adjusts systematically.

23. An apparatus as recited in claim 22 wherein means for generating input signals further comprises:
means for examining a current configuration of the display system.

24. An apparatus as recited in claim 22 wherein an amount of a user human visual field that is filled by the display system is increased.

25. An apparatus as recited in claim 22 further comprising a plurality of renderers, wherein a display element in the display system has its own renderer.

26. An apparatus as recited in claim 22 further comprising:
means for adjusting the display system configuration according to a user gaze, thereby adapting to user movements.

27. An apparatus as recited in claim 22 further comprising:
means for transitioning the display system configuration between a generally horizontal configuration and a generally vertical configuration, wherein configuration includes orientation, shape, and curvature of display elements.

28. A display system comprising:
a processor;
a network interface;
at least two planar display elements;
an actuator;
an actuator signal module having access to a display system configuration stored in a data storage component; and
a user tracking component.

29. A display system as recited in claim 28 wherein the actuator signal module further comprises:
a control module for creating a signal that can be input to the actuator.

30. A display system as recited in claim 28 wherein the at least two planar display elements further comprises at least one hinge.

31. A display system as recited in claim 28 wherein the user tracking component is a camera.
